(19) United States
(12) Patent Application Publication
(10) Pub. No.: US 2024/0060515 A1
(43) Pub. Date: Feb. 22, 2024

(54) FLUID PRESSURE DRIVING DEVICE

(71) Applicants: The Ritsumeikan Trust, Kyoto-shi, Kyoto (JP); MORI KOGYO Co., Ltd., Shizuoka-shi, Shizuoka (JP)

(72) Inventors: Sang-Ho HYON, Kyoto (JP); Harutsugu MIZUI, Ichikawa-shi, Chiba (JP)

(73) Assignees: The Ritsumeikan Trust, Kyoto-shi, Kyoto (JP); MORI KOGYO Co., Ltd., Shizuoka-shi, Shizuoka (JP)

(21) Appl. No.: 17/754,558

(22) PCT Filed: Oct. 6, 2020
(86) PCT No.: PCT/JP2020/037901

§ 371 Date: Apr. 6, 2022

(30) Foreign Application Priority Data
Oct. 7, 2019 (JP) 2019-184405

(51) Int. Cl. F15B 11/036; F15B 15/14

(52) U.S. Cl. CPC F15B 11/0365; F15B 15/1447; F15B 15/149; F15B 2211/7055; F15B 2211/8855

(57) ABSTRACT

A fluid pressure driving device includes a first air-fluid converter and a second air-fluid converter each configured to convert air pressure supplied from an air pressure source to fluid pressure, a fluid pressure actuator having a first pressure chamber and a second pressure chamber, an operation state acquisition unit configured to acquire an operation state of the fluid pressure actuator, and first and second air pressure valves respectively provided on first and second air supply paths, the first and second air supply paths being configured to supply air from the air pressure source to the first and second air-fluid converters respectively, wherein the control device is configured to control the first air pressure valve and the second air pressure valve on the basis of an acquired result from the operation state acquisition unit.

### TECHNICAL FIELD

The present invention relates to a fluid pressure driving device that drives a fluid pressure actuator by converting air pressure supplied from an air pressure source to fluid pressure.

### BACKGROUND ART

Compared with a hydraulic drive, a water pressure drive utilizing tap water, etc. has advantages that it is easier to obtain and dispose working fluid, it has less risk for fire and contamination, it is excellent in terms of sanitation, and it can be washed as a whole. Water pressure driven apparatuses are used in areas of food processing, outdoor work, and so forth.

Risks associated with the water pressure drive include: 1) formation of rust; 2) deterioration of water; 3) increased leakage and insufficient lubrication due to low viscosity, 4) generation of cavitation; and so forth. The risk 1) can be avoided by using materials such as stainless steel, etc., and the risk 2) can be solved by exchanging water. However, the risks 3) and 4) become prominent in particular under higher pressure. For example, in a water pressure pump, because metal parts come into contact with each other under a high pressure and at a high speed within the pump, there is a risk of seizure due to an insufficient lubrication, and therefore, structural innovations are required. The same applies to an EHA (Electro Hydrostatic Actuator) that directly connects a pump to a cylinder. In addition, although servovalves are suitably used for hydraulic robots, in a case in which the servovalves are replaced with those of water pressure driven type, similar innovations are required. Thus, costs for commercial water pressure pumps and water pressure servovalves are significantly high at present, and it cannot be said that they are widely used.

In addition, the inventors of the present application have proposed fluid pressure driving devices as disclosed in JP2015-96757A and JP2015-178885A. In these fluid pressure driving devices, a first pressure chamber of a fluid pressure actuator is supplied with a pressure fluid from an air-hydro converter, which converts the air pressure from an air pressure source to the fluid pressure, and from an air-hydro booster, which converts the air pressure from the air pressure source to boosted fluid pressure. As the pressure fluid is supplied to the first pressure chamber, a rod of the fluid pressure actuator is moved downward. From this state, as air is supplied to a second pressure chamber of the fluid pressure actuator from the air pressure source, the rod of the fluid pressure actuator is moved upward.

JPS62-167908U describes that a first air-oil converter, a second air-oil converter, and a pressure-boosting type air-oil converter are operated by performing switching operations of two switching valves.

### SUMMARY OF INVENTION

The fluid pressure driving devices disclosed in JP2015-96757A and JP2015-178885A are of a single side fluid-pressure driven type. In other words, because the movement of the fluid pressure actuator in one direction of the reciprocating movement is achieved directly by the air from the air pressure source, in a case in which the fluid pressure driving devices are applied to the fluid pressure actuator, the direction of the motion of which is switched between the positive direction and the negative direction, the fluid pressure actuator cannot be moved smoothly.

In JPS62-167908U, it is not clear how to perform the control of the two switching valves. Therefore, there is a risk in that the hydraulic actuator cannot be driven suitably.

An object of the present invention is to provide a fluid pressure driving device capable of realizing control of a fluid pressure actuator with ease.

According to one aspect of the present invention, a fluid pressure driving device includes: a first air-fluid converter and a second air-fluid converter each configured to convert air pressure supplied from an air pressure source to fluid pressure; a fluid pressure actuator having: a hollow cylinder chamber; a piston provided in the cylinder chamber so as so be reciprocatable; and a rod provided on the piston, an interior of the cylinder chamber being delimited into a first pressure chamber and a second pressure chamber by the piston, pressure fluid being supplied from the first air-fluid converter to the first pressure chamber, and the pressure fluid being supplied from the second air-fluid converter to the second pressure chamber; an operation state acquisition unit configured to acquire an operation state of the fluid pressure actuator; a first air pressure valve provided on a first air supply path, the first air supply path being configured to supply air from the air pressure source to the first air-fluid converter; a second air pressure valve provided on a second air supply path, the second air supply path being configured to supply the air from the air pressure source to the second air-fluid converter; and a control device configured to control supply of the pressure fluid to the first pressure chamber and the second pressure chamber, wherein the first air-fluid converter is an air-hydro converter or an air-hydro booster, the air-hydro converter being configured to convert the air pressure supplied from the air pressure source to the fluid pressure, and the air-hydro booster being configured to convert the air pressure supplied from the air pressure source to boosted fluid pressure, the second air-fluid converter is an air-hydro converter or an air-hydro booster, the air-hydro converter being configured to convert the air pressure supplied from the air pressure source to the fluid pressure, and the air-hydro booster being configured to convert the air pressure supplied from the air pressure source to the boosted fluid pressure, and the control device is configured to control the first air pressure valve and the second air pressure valve on the basis of an acquired result from the operation state acquisition unit.

### BRIEF DESCRIPTION OF DRAWINGS

FIG. 1 is a schematic view showing a fluid pressure driving device according to a first embodiment of the present invention.

FIG. 2 is a schematic view showing a fluid pressure driving device according to a second embodiment of the present invention.

FIG. 3 is a schematic view showing a modification of the fluid pressure driving device according to the second embodiment of the present invention.

FIG. 4 is a schematic view showing a modification of the fluid pressure driving device according to the embodiment of the present invention.

FIG. 5 is a schematic view showing a modification of the fluid pressure driving device according to the embodiment of the present invention.

### DESCRIPTION OF EMBODIMENTS

In the following, embodiments of the present invention will be described in detail based on the drawings.

### First Embodiment

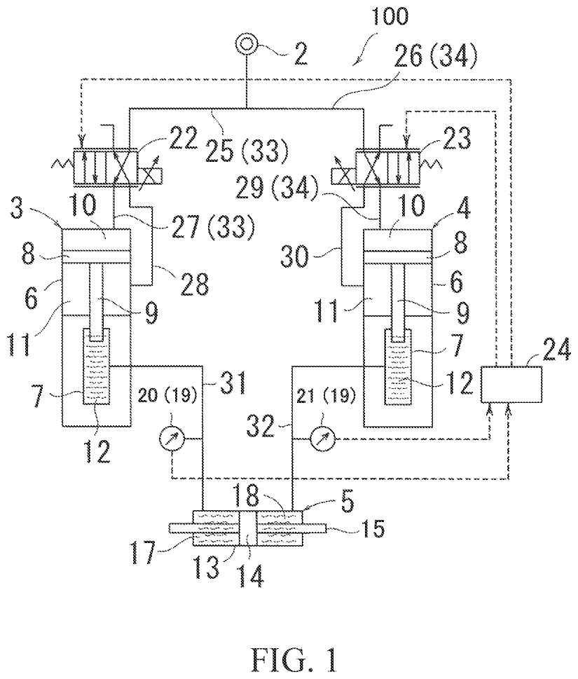

A fluid pressure driving device 100 according to a first embodiment of the present invention will be described first with reference to FIG. 1. FIG. 1 is a schematic view showing the fluid pressure driving device 100.

The fluid pressure driving device 100 includes a first air-fluid converter (air-fluid converting means) 3 and a second air-fluid converter (the air-fluid converting means) 4 that convert the air pressure supplied from an air pressure source 2 to the fluid pressure, and a fluid pressure actuator 5 that is operated by both of the air-fluid converters 3 and 4. Although applications are not specifically limited, the fluid pressure driving device 100 is, for example, used for robots with a joint for a food processing.

The first air-fluid converter 3 and the second air-fluid converter 4 are air-hydro boosters having the same configuration with each other. The air-hydro booster is an air-fluid pressure booster that converts the air pressure supplied from the air pressure source 2 to the boosted fluid pressure. The air-fluid converters 3 and 4 each have: two hollow cylinders 6 and 7 having different inner diameters; a piston 8 that is provided in the cylinder 6 so as to be reciprocatable; and a rod 9 provided on the piston 8. For the two cylinders 6 and 7, an interior of the cylinder 6 having the larger inner diameter is delimited into a first air pressure chamber 10 and a second air pressure chamber 11 by the piston 8. In addition, an interior of a fluid pressure chamber 12 of the cylinder 7 having the smaller inner diameter is filled with working fluid such as water, etc. The rod 9 is fixed to the second air pressure chamber 11 side of the piston 8. As the piston 8 is moved, the rod 9 is inserted into the cylinder 7 having the smaller inner diameter. In the first embodiment, the air pressure source 2 that supplies the air to the air-fluid converters 3 and 4 is a compressor, for example.

A fluid pressure actuator 5 has: a hollow cylinder chamber 13; a piston 14 that is provided in the cylinder chamber 13 so as to be reciprocatable; and a rod 15 that is provided on the piston 14. An interior of the cylinder chamber 13 is delimited into a first pressure chamber 17 and a second pressure chamber 18 by the piston 14. The fluid pressure actuator 5 is a double rod type fluid pressure cylinder, and the rod 15 is provided so as to project out from both end surfaces of the piston 14. The fluid pressure actuator 5 may be a single rod type fluid pressure cylinder.

The fluid pressure driving device 100 is further includes: an operation state acquisition unit 19 that acquires an operation state of the fluid pressure actuator 5; a first air pressure valve 22 that is provided on a flow path for supplying the air from the air pressure source 2 to the first air-fluid converter 3; a second air pressure valve 23 that is provided on a flow path for supplying the air from the air pressure source 2 to the second air-fluid converter 4; and a control device (control means) 24 that controls the air pressure valves 22 and 23.

In the first embodiment, the operation state acquisition unit 19 has a first pressure acquisition unit (pressure acquisition means) 20 that acquires the pressure of the pressure fluid in the first pressure chamber 17 and a second pressure acquisition unit (the pressure acquisition means) 21 that acquires the pressure of the pressure fluid in the second pressure chamber 18. In the first embodiment, the pressure acquisition units 20 and 21 are each a pressure sensor that detects and acquires the pressure. Acquired results (pressure values) from the pressure acquisition units 20 and 21 are output to the control device 24. The air pressure valves 22 and 23 are servovalves for respectively supplying the air from the air pressure source 2 to the air-fluid converters 3 and 4 by adjusting the flow rate of the air.

As shown in FIG. 1, the air pressure source 2 is provided with a path 25 and a path 26 that are branched in two ways. The path 25 is connected to the first air pressure valve 22, and a first end portion of a path 27 is connected to the first air pressure valve 22. A second end portion of the path 27 is connected to the first air pressure chamber 10 of the first air-fluid converter 3. In addition, a first end portion of a path 28 is connected to the first air pressure valve 22, and a second end portion of the path 28 is connected to the second air pressure chamber 11 of the first air-fluid converter 3.

The path 26 is connected to the second air pressure valve 23. The connection between the second air pressure valve 23 and the second air-fluid converter 4 is similar to the connection between the first air pressure valve 22 and the first air-fluid converter 3. In other words, the second air pressure valve 23 is connected to the first air pressure chamber 10 of the second air-fluid converter 4 via a path 29 corresponding to the path 27, and the second air pressure valve 23 is connected to the second air pressure chamber 11 of the second air-fluid converter 4 via a path 30 corresponding to the path 28.

As shown in FIG. 1, the first air-fluid converter 3 is connected to the first pressure chamber 17 of the fluid pressure actuator 5 via a first fluid pressure path 31 that supplies the pressure fluid from the first air-fluid converter 3 to the first pressure chamber 17. Specifically, a first end portion of the first fluid pressure path 31 is connected to the cylinder 7 having the smaller inner diameter of the first air-fluid converter 3 and a second end portion of the first fluid pressure path 31 is connected to the first pressure chamber 17. The first fluid pressure path 31 is provided with the first pressure acquisition unit 20. The cylinder 7 having the smaller inner diameter of the second air-fluid converter 4 is connected to the second pressure chamber 18 of the fluid pressure actuator 5 via a second fluid pressure path 32 that supplies the pressure fluid from the second air-fluid converter 4 to the second pressure chamber 18. The second fluid pressure path 32 is provided with the second pressure acquisition unit 21. The first pressure acquisition unit 20 and the second pressure acquisition unit 21 may be provided on the first pressure chamber 17 and the second pressure chamber 18, respectively.

On the basis of the acquired results from the pressure acquisition units 20 and 21, the control device 24 controls the first air pressure valve 22 and the second air pressure valve 23 to control the supply of the pressure fluid from the air-fluid converters 3 and 4 to the fluid pressure actuator 5. The pressure acquisition units 20 and 21 and the air pressure valves 22 and 23 are electrically connected to the control device 24. The control device 24 is formed of a microcomputer having a central processing unit (a CPU), a read-only memory (a ROM), a random access memory (a RAM), and an input/output interface (an I/O interface). It may also be possible to form the control device 24 with a plurality of microcomputers. For example, the control device 24 controls the fluid pressure actuator 5 by performing feedback control on the basis of the acquired results from the pressure acquisition units 20 and 21.

Next, the operation of the fluid pressure driving device 100 will be described. When the fluid pressure actuator 5 is to be operated, the compressor, which is the air pressure source 2, is first driven. As described above, the configurations of the air-fluid converters 3 and 4 are the same with each other, and therefore, the configurations for supplying the air from the air pressure source 2 to the air-fluid converters 3 and 4 are also the same with each other. In addition, the configurations for supplying the pressure fluid from the air-fluid converters 3 and 4 to the fluid pressure actuator 5 are the same with each other. Therefore, the operation of only the first air-fluid converter 3 among the air-fluid converters 3 and 4 will be described. In the first embodiment, the air is supplied to the air-fluid converters 3 and 4 from the air pressure source 2 provided in common.

By operating the first air pressure valve 22 as the air pressure source 2 is driven, the air pressure source 2 is communicated with the first air pressure chamber 10 of the first air-fluid converter 3 via the paths 25 and 27, and the air is supplied from the air pressure source 2 to the first air pressure chamber 10 through the first air pressure valve 22. In other words, in a case in which the air is to be supplied from the air pressure source 2 to the first air pressure chamber 10 of the first air-fluid converter 3, the paths 25 and 27 serve as a first air supply path 33 that is a flow path for supplying the air from the air pressure source 2 to the first air pressure chamber 10. In a case in which the air is to be supplied from the air pressure source 2 to the first air pressure chamber 10 as described above, the second air pressure chamber 11 of the first air-fluid converter 3 is communicated with the first air pressure valve 22 via the path 28, and the second air pressure chamber 11 is communicated with the outside. Thus, as the air is supplied from the air pressure source 2 to the first air pressure chamber 10 through the first air supply path 33, the piston 8 is moved in the direction in which the first air pressure chamber 10 is expanded (the downward in FIG. 1). At this time, the air in the second air pressure chamber 11 is discharged to the outside from the first air pressure valve 22 through the path 28.

As the piston 8 is moved downward, the rod 9 fixed to the piston 8 enters the fluid pressure chamber 12, and the working fluid in the fluid pressure chamber 12 is pushed out from the fluid pressure chamber 12 by an amount corresponding to the volume of the rod 9 that has entered. With such a configuration, the working fluid in the fluid pressure chamber 12 is supplied as the pressure-boosted pressure fluid to the first pressure chamber 17 of the fluid pressure actuator 5 through the first fluid pressure path 31. The working fluid in the fluid pressure chamber 12 is boosted because a pressure receiving area of the rod 9 (the area of a portion of the rod 9 that pushes out the working fluid in the fluid pressure chamber 12) is, for example, R times smaller than a pressure receiving area of the piston 8 (the area of a portion of the piston 8 that receives the air pressure).

As described above, the working fluid in the fluid pressure chamber 12 of the first air-fluid converter 3 is supplied under pressure to the first pressure chamber 17 of the fluid pressure actuator 5 through the first fluid pressure path 31. If the piston 14 of the fluid pressure actuator 5 is stopped and is not moved, the pressure in the fluid pressure chamber 12 becomes R times. In contrast, if the fluid pressure actuator 5 is under no load, the piston 14 is moved towards the right in FIG. 1. The pressure in the fluid pressure chamber 12 is determined by the load on the fluid pressure actuator 5.

Here, although a description has been given of the case for the first air-fluid converter 3, the same applies to the case for the second air-fluid converter 4. In other words, as the air is supplied from the air pressure source 2 to the second air-fluid converter 4 through a second air supply path 34, which is formed of the paths 26 and 29, the working fluid in the fluid pressure chamber 12 of the second air-fluid converter 4 is supplied as the pressure-boosted pressure fluid to the second pressure chamber 18 of the fluid pressure actuator 5 through the second fluid pressure path 32. By simultaneously operating both of the air pressure valves 22 and 23 as described above, the differential pressure between the first pressure chamber 17 and the second pressure chamber 18 acts on the piston 14, and the load is applied to the piston 14 additionally, and thereby, the acceleration of the piston 14 is determined. Thus, the piston 14 of the fluid pressure actuator 5 is driven by the fluid pressure from both of the air-fluid converters 3 and 4.

As described above, in the air-fluid converters 3 and 4, by communicating the air pressure source 2 with the first air pressure chamber 10, it is possible to move the piston 8 in the direction in which the rod 9 enters the fluid pressure chamber 12 (the downward in FIG. 1). On the other hand, in order to move the piston 8 in the direction in which the rod 9 moves out from the fluid pressure chamber (the upward in FIG. 1), it suffices to communicate the air pressure source 2 with the second air pressure chamber 11. In this case, the air is supplied from the air pressure source 2 to the second air pressure chamber 11 via the first air pressure valve 22 by driving the air pressure source 2 and by operating the first air pressure valve 22 to communicate the air pressure source 2 with the second air pressure chamber 11 of the first air-fluid converter 3 through the paths 25 and 28. At this time, the first air pressure chamber 10 of the first air-fluid converter 3 communicates with the first air pressure valve 22 through the path 27, and the first air pressure chamber 10 communicates with the outside. Therefore, by supplying the air from the air pressure source 2 to the second air pressure chamber 11, the piston 8 is moved in the direction in which the second air pressure chamber 11 is to be expanded (the upward in FIG. 1). At this time, the air in the first air pressure chamber 10 is discharged to the outside from the first air pressure valve 22 through the path 27.

A series of operations of the fluid pressure actuator 5 as described above is executed by the control device 24. The control device 24 controls the air pressure valves 22 and 23 on the basis of the acquired results from the pressure acquisition units 20 and 21 to control the supply of the pressure fluid to the pressure chambers 17 and 18 of the fluid pressure actuator 5. Specifically, the control device 24 sets target values for the pressure of the pressure fluid in the first pressure chamber 17 and the pressure of the pressure fluid in the second pressure chamber 18 and performs the feedback control such that the piston 14 follows these target values. During this control, because the speed of and the load on the piston 14 are switched between positive values and negative values, the air pressure valves 22 and 23 are driven suitably in accordance with the required levels and the directions of the speed and load. As described above, the differential pressure is monitored by the pressure acquisition units 20 and 21, and the air pressure valves 22 and 23 are operated in accordance with the differential pressure, and thereby, the fluid pressure actuator 5 is operated such that the rod 15 is reciprocated.

In the fluid pressure driving device 100, the conversion from the air pressure to the fluid pressure behaves as a function of a type of decelerator, and the flow rate of the working fluid is 1/R times lower than the flow rate of the air. Thus, compared with a case in which the fluid pressure actuator 5 is directly driven by an air pressure valve only, an accuracy level is improved by R times. In addition, even though the air pressure is at most 1 MPa, when R is 10, it is possible to obtain the fluid pressure of 10 MPa.

In the fluid pressure driving device 100, the pressure fluid is supplied to the fluid pressure actuator 5 from the air-fluid converters 3 and 4 that convert the air pressure to the fluid pressure. Thus, compared with a case in which a conventional water pressure pump, water pressure servovalve, and so forth is used, it is possible to reduce the cost required for the fluid pressure driving device for obtaining the practical fluid pressure. In addition, in the fluid pressure driving device 100, because it is possible to reciprocate the fluid pressure actuator 5 by using the air-fluid converters 3 and 4, it is possible to make the reciprocating movement of the fluid pressure actuator 5 smoother.

In addition, in the fluid pressure driving device 100, because the air-fluid converters 3 and 4 are the air-hydro boosters having the same configuration with each other, it is possible to achieve a simple configuration. In addition, in the fluid pressure driving device 100, the supply of the pressure fluid to the pressure chambers 17 and 18 of the fluid pressure actuator 5 is controlled on the basis of acquired signals from the pressure acquisition units 20 and 21. Thus, it is possible to control the fluid pressure actuator 5 of the double rod type with ease. In addition, in the fluid pressure driving device 100, because the supply of the pressure fluid to the pressure chambers 17 and 18 is controlled by controlling the air pressure valves 22 and 23, it is possible to realize the control of the fluid pressure actuator 5 with a low-cost configuration.

In addition, in the fluid pressure driving device 100, because both of the pressure chambers 17 and 18 of the fluid pressure actuator 5 are under pressure constantly, it is possible to suppress generation of the cavitation. Furthermore, in the fluid pressure driving device 100, because the air pressure valves 22 and 23 are the servovalves, it is possible to control the flow rate of the air to be supplied to the air-fluid converters 3 and 4 with ease.

### Second Embodiment

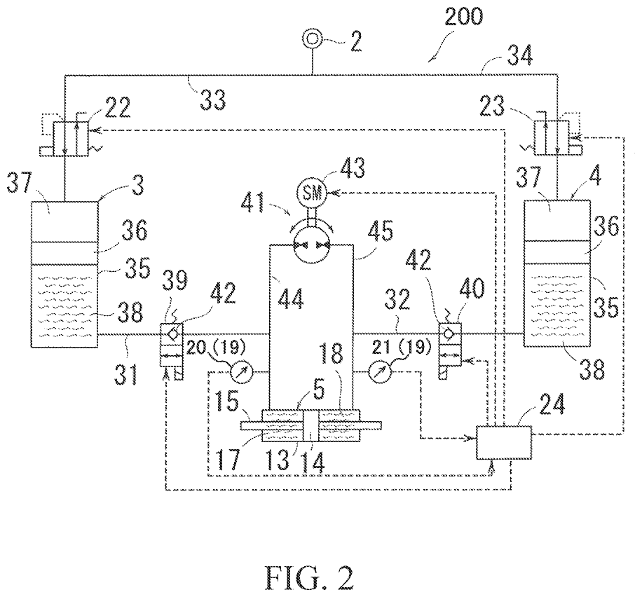

Next, a fluid pressure driving device 200 according to a second embodiment of the present invention will be described with reference to FIG. 2. FIG. 2 is a schematic view showing the fluid pressure driving device 200.

The fluid pressure driving device 200 according to the second embodiment is essentially be the same as the fluid pressure driving device 100 according to the above-described first embodiment. Thus, in the following, differences between both embodiments will be mainly described, and corresponding components are described by assigning the same reference numerals. In addition, descriptions will be omitted for aspects in common between the first embodiment and the second embodiment.

Although the air-fluid converters 3 and 4 are the air-hydro boosters in the above-described first embodiment, in this second embodiment, the air-fluid converters 3 and 4 are air-hydro converters. The air-fluid converters 3 and 4 are the air-hydro converters having the same configuration with each other. The air-hydro converters are each an air-fluid converter that converts the air pressure supplied from the air pressure source 2 to the fluid pressure. The air-fluid converters 3 and 4 are each provided with a hollow cylinder 35 and a piston 36 provided in the cylinder 35 so as to be reciprocatable. An interior of the cylinder 35 is delimited into an air chamber 37 and a liquid chamber 38 by the piston 36, and the liquid chamber 38 is filled with the working fluid such as water, etc.

In this second embodiment, one of flow paths that are branched from the air pressure source 2 in two ways is the first air supply path 33, and the first air supply path 33 is connected to the air chamber 37 of the first air-fluid converter 3. The other of the flow paths that are branched in two ways is the second air supply path 34, and the second air supply path 34 is connected to the air chamber 37 of the second air-fluid converter 4. In this second embodiment, the first air pressure valve 22 provided on the first air supply path 33 and the second air pressure valve 23 provided on the second air supply path 34 are each an electro-pneumatic regulator that adjusts the air pressure to be supplied from the air pressure source 2 to the air chamber 37 at a predetermined pressure. The electro-pneumatic regulator is an apparatus that adjusts the air pressure in a manner proportional to an input that is an electric signal. While the liquid chamber 38 of the first air-fluid converter 3 is connected to the first pressure chamber 17 of the fluid pressure actuator 5 via the first fluid pressure path 31, the liquid chamber 38 of the second air-fluid converter 4 is connected to the second pressure chamber 18 of the fluid pressure actuator 5 via the second fluid pressure path 32.

The fluid pressure driving device 200 includes, in addition to the configuration of the fluid pressure driving device 100 according to the above-described first embodiment, a first liquid supply valve 39, a second liquid supply valve 40, and a fluid pressure pump 41 with a small capacity. The first liquid supply valve 39 is provided on the first fluid pressure path 31, and the second liquid supply valve 40 is provided on the second fluid pressure path 32. In this second embodiment, the liquid supply valves 39 and 40 are each a solenoid valve capable of being opened/closed by being switched on/off and are each provided with an integrated check valve 42 that allows only flow of the fluid from each of the air-fluid converters 3 and 4 to the fluid pressure actuator 5. The fluid pressure pump 41 is a servopump having a small capacity that is configured so as to be rotatable in both directions by an electric motor such as a servomotor 43, etc., and the fluid pressure pump 41 can be rotated in the positive/negative directions selectively.

The fluid pressure pump 41 is connected to the first pressure chamber 17 of the fluid pressure actuator 5 via a first auxiliary path 44 and is connected to the second pressure chamber 18 of the fluid pressure actuator 5 via a second auxiliary path 45. In this second embodiment, a part of the first fluid pressure path 31 and a part of the first auxiliary path 44 form a common path on the side of the first pressure chamber 17 of the fluid pressure actuator 5. The first pressure acquisition unit 20 is provided on the common path of the first fluid pressure path 31 and the first auxiliary path 44, and the first liquid supply valve 39 is provided on the first fluid pressure path 31 on the upstream side of the common path. In addition, a part of the second fluid pressure path 32 and a part of the second auxiliary path 45 form the common path on the side of the second pressure chamber 18 of the fluid pressure actuator 5. The second pressure acquisition unit 21 is provided on the common path of the second fluid pressure path 32 and the second auxiliary path 45, and the second liquid supply valve 40 is provided on the second fluid pressure path 32 on the upstream side of the common path.

Also in this second embodiment, the control device 24 controls the air pressure valves 22 and 23 on the basis of the acquired results from the pressure acquisition units 20 and 21 to control the supply of the pressure fluid to the pressure chambers 17 and 18 of the fluid pressure actuator 5. This control is the same as the feedback control performed in the above-described first embodiment.

In this second embodiment, the control device 24 also controls the fluid pressure pump 41 on the basis of the acquired results from the pressure acquisition units 20 and 21. The liquid supply valves 39 and 40 and the servomotor 43 of the fluid pressure pump 41 are electrically connected to the control device 24.

Next, the operation of the fluid pressure driving device 200 will be described. In the fluid pressure driving device 200, there are a case in which the fluid pressure actuator 5 is operated at a high speed and a case in which the fluid pressure actuator 5 is operated at a low speed. In the former case, the rod 15 of the fluid pressure actuator 5 is reciprocated rapidly under a small load. In the latter case, the rod 15 of the fluid pressure actuator 5 is reciprocated slowly under a high load.

The air-fluid converters 3 and 4 are used when the fluid pressure actuator 5 is to be driven at a high speed under a small load. In this case, the control device 24 drives the air-fluid converters 3 and 4 in a state in which the fluid pressure pump 41 is stopped and the liquid supply valves 39 and 40 are opened. In this case, similarly to the feedback control performed in the above-described first embodiment, the supply of the pressure fluid to the pressure chambers 17 and 18 of the fluid pressure actuator 5 is controlled by controlling the air pressure valves 22 and 23 on the basis of the acquired results from the pressure acquisition units 20 and 21. In this second embodiment, the air-fluid converters 3 and 4 are each the air-hydro converter. Thus, as the air is supplied from the air pressure source 2 to the air chamber 37 of the first air-fluid converter 3 via the first air pressure valve 22, the piston 36 is moved in the direction in which the air chamber 37 is expanded (the downward in FIG. 2). With such a configuration, the working fluid in the liquid chamber 38 of the first air-fluid converter 3 is supplied as the pressure fluid to the first pressure chamber 17 of the fluid pressure actuator 5 through the first fluid pressure path 31. On the other hand, as the air is supplied from the air pressure source 2 to the air chamber 37 of the second air-fluid converter 4 via the second air pressure valve 23, the pressure fluid is supplied from the second air-fluid converter 4 to the second pressure chamber 18 of the fluid pressure actuator 5 through the second fluid pressure path 32.

The fluid pressure pump 41 is used when the fluid pressure actuator 5 is to be driven at a low speed under a high load. In this case, the control device 24 drives the fluid pressure pump 41 in a state in which the liquid supply valves 39 and 40 are closed. Specifically, the control device 24 sets the target values for the pressure of the pressure fluid in the first pressure chamber 17 and the pressure of the pressure fluid in the second pressure chamber 18 and performs the feedback control such that the piston 14 follows these target values. During this control, because the speed of and the load on the piston 14 are switched between positive values and negative values, the fluid pressure pump 41 is driven suitably in accordance with the required levels and the directions of the speed and load. As described above, the fluid pressure pump 41 is controlled on the basis of the acquired results from the pressure acquisition units 20 and 21. In this second embodiment, it may be possible to cause the required differential pressure to act on the piston 14 also by driving the fluid pressure pump 41 in a state in which the liquid supply valves 39 and 40 are closed.

With the fluid pressure driving device 200 according to this second embodiment, because the fluid pressure actuator 5 can be operated by using the fluid pressure pump 41 having a small capacity, compared with a case in which the fluid pressure actuator 5 is operated by using the air-hydro converter, it is possible to control the fluid pressure actuator 5 more accurately. In addition, in the fluid pressure driving device 200, because the air-fluid converters 3 and 4 are the air-hydro converters having the same configuration with each other, it is possible to achieve a simple configuration. Furthermore, in the fluid pressure driving device 200, because the check valve 42 is integrated in each of the liquid supply valves 39 and 40, the pressure in the pressure chambers 17 and 18 of the fluid pressure actuator 5 does not become lower than the air pressure in the air chamber 37, and thereby, it is possible to suppress the generation of the cavitation.

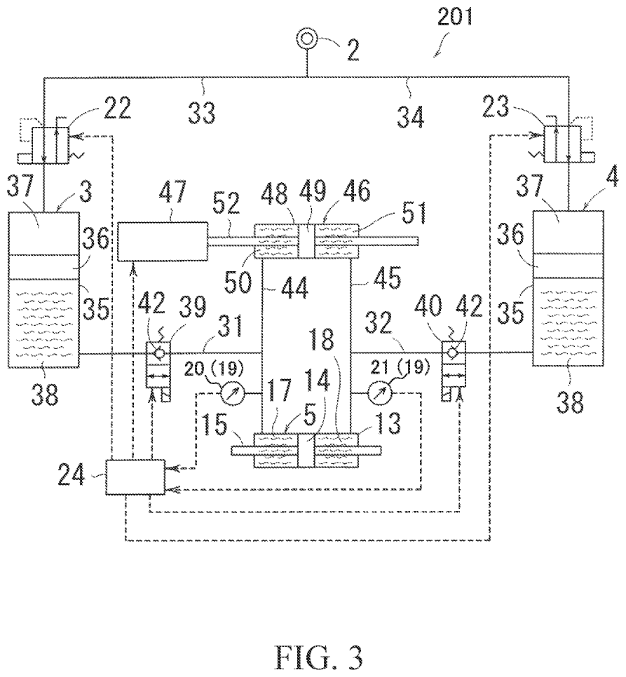

Next, a fluid pressure driving device 201 that is a modification of the second embodiment will be described with reference to FIG. 3. FIG. 3 is a schematic view showing the fluid pressure driving device 201. Here, differences from the fluid pressure driving device 200 will be mainly described, and those described above are applied for other configurations and controls.

In this modification, instead of the fluid pressure pump 41 used in the fluid pressure driving device 200 according to the above-described second embodiment, a fluid pressure cylinder 46 and a driving device (driving means) 47 thereof are provided. The fluid pressure cylinder 46 has: a hollow cylinder main body 48; and a movable piston 49 that is provided in the cylinder main body 48 so as to be reciprocatable. An interior of the cylinder main body 48 is delimited into a first liquid chamber 50 and a second liquid chamber 51 by the movable piston 49, and the first liquid chamber 50 and the second liquid chamber 51 are each filled with the working fluid such as water, etc. The first liquid chamber 50 is connected to the first pressure chamber 17 of the fluid pressure actuator 5 via the first auxiliary path 44, and the second liquid chamber 51 is connected to the second pressure chamber 18 of the fluid pressure actuator 5 via the second auxiliary path 45. The driving device 47 is means for causing the movable piston 49 of the fluid pressure cylinder 46 to be reciprocated and is a small motor in this modification. The driving device 47 is connected to the movable piston 49 of the fluid pressure cylinder 46 via a rod 52.

Also in this modification, similarly to the feedback control performed in the above-described second embodiment, the control device 24 controls the supply of the pressure fluid to the pressure chambers 17 and 18 of the fluid pressure actuator 5 by controlling the air pressure valves 22 and 23 on the basis of the detected results of the pressure acquisition units 20 and 21. In addition, in this modification, the control device 24 also controls the driving device 47 of the fluid pressure cylinder 46 on the basis of the acquired results for the pressure acquisition units. The driving device 47 of the fluid pressure cylinder 46 is electrically connected to the control device 24.

Next, the operation of the fluid pressure driving device 201 will be described. In the fluid pressure driving device 201, similarly to the fluid pressure driving device 200, there are a case in which the fluid pressure actuator 5 is driven at a high speed under a small load and a case in which the fluid pressure actuator 5 is driven at a low speed under a high load. In the former case, similarly to the case in which the fluid pressure driving device 200 is driven at a high speed, the fluid pressure actuator 5 is operated by using the air-fluid converters 3 and 4. At this time, the control device 24 drives the air-fluid converters 3 and 4 in a state in which the driving device 47 of the fluid pressure cylinder 46 is stopped and the liquid supply valves 39 and 40 are opened.

In the latter case, the fluid pressure cylinder 46 is used. At this time, the control device 24 reciprocates the movable piston 49 of the fluid pressure cylinder 46 by driving the driving device 47 in a state in which the liquid supply valves 39 and 40 are closed. Specifically, the control device 24 sets the target values for the pressure of the pressure fluid in the first pressure chamber 17 and the pressure of the pressure fluid in the second pressure chamber 18 and performs the feedback control such that the piston 14 follows these target values. During this control, because the speed of and the load on the piston 14 are switched between positive values and negative values, the driving device 47 is driven suitably in accordance with the required levels and the directions of the speed and load. As described above, the driving device 47 is controlled on the basis of the acquired results from the pressure acquisition units 20 and 21. With such a configuration, as the movable piston 49 of the fluid pressure cylinder 46 is reciprocated, the working fluid is supplied from the first liquid chamber 50 to the first pressure chamber 17, and the working fluid is supplied from the second liquid chamber 51 to the second pressure chamber 18. In this modification, in order to ensure the required differential pressure acting on the piston 14, the volumetric capacity of the cylinder main body 48 of the fluid pressure cylinder 46 is sufficiently smaller relative to the volumetric capacity of the cylinder chamber 13 of the fluid pressure actuator 5.

With the fluid pressure driving device 201 according to this modification, it is possible to operate the fluid pressure actuator 5 by using the fluid pressure cylinder 46 and the driving device 47 thereof. Thus, it is possible to adjust the flow rate of the working fluid to be supplied to the fluid pressure actuator 5 from the fluid pressure cylinder 46 to a small amount, and thereby, compared with a case in which the fluid pressure actuator 5 is operated by using the air-hydro converter, it is possible to control the fluid pressure actuator 5 more accurately.

Next, modifications of the fluid pressure driving devices 100, 200, and 201 will be described. The modifications described below also fall within the scope of the present invention. It may be possible to combine the following modifications with the respective configurations of the above-described fluid pressure driving devices 100, 200, and 201 shown in FIGS. 1 to 3, and it may also be possible to combine the following modifications with each other. In the descriptions of the following modifications, the descriptions will be made using the same reference signs for the same configurations with those in the above-mentioned embodiments.

(1) In the above-described first embodiment, although the air pressure valves 22 and 23 are the servovalves, they may be the electro-pneumatic regulators. In this case, one of the flow paths that are branched from the air pressure source 2 in two ways is the first air supply path 33 that is connected to the first air pressure chamber 10 of the first air-fluid converter 3 and the other of the flow paths is the second air supply path 34 that is connected to the first air pressure chamber 10 of the second air-fluid converter 4. In addition, the second air pressure chamber 11 of each of the air-fluid converters 3 and 4 is configured such that the air inside can be released to the outside.

(2) The above-described first embodiment may be configured so as to be provided with the fluid pressure pump 41 in the above-described second embodiment or the fluid pressure cylinder 46 and the driving device 47 thereof in the above-described modification.

(3) In the above-described first embodiment, the air-fluid converters 3 and 4 are the air-hydro boosters, and in the second embodiment and in the above-described modification, the air-fluid converters 3 and 4 are the air-hydro converters. However, the one of the air-fluid converters 3 and 4 may be the air-hydro booster and the other may be the air-hydro converter.

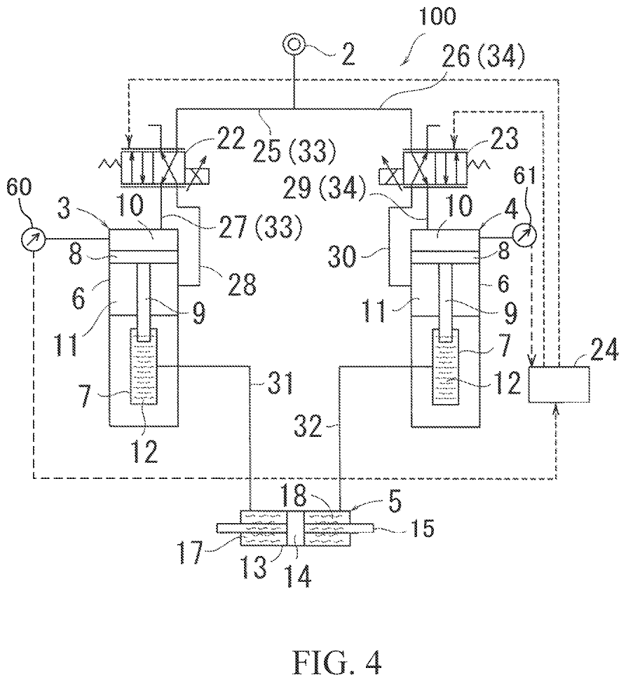

(4) For the fluid pressure driving devices 100, 200, and 201, the descriptions are given of the configurations in which the pressure acquisition units 20 and 21 for acquiring the pressures of the pressure fluid in the pressure chambers 17 and 18 are each the pressure sensor that detects and acquires the pressure. Instead of detecting pressures of the pressure fluid in the pressure chambers 17 and 18 as the pressure acquisition unit, it may be possible to acquire the pressures of the pressure fluid in the pressure chambers 17 and 18 by performing computation. For example, as shown in FIG. 4, the pressure sensors provided on the fluid pressure paths 31 and 32 are omitted, and pressure sensors 60 and 61 that detect the pressure of the air in the air pressure chambers 10 are provided respectively on the air-fluid converters 3 and 4. Detected values by the pressure sensors 60 and 61 are then output to the control device 24, and the pressures of the pressure fluid in the pressure chambers 17 and 18 are computed by the control device 24 on the basis of the detected values from the pressure sensors 60 and 61. Specifically, the control device 24 computes the pressures of the pressure fluid in the pressure chambers 17 and 18 by using a force equilibrium formula determined from the detected values from the pressure sensors 60 and 61 and the pressure receiving areas of the pistons 8 and the rods 9 in consideration of pressure losses at the fluid pressure paths 31 and 32, etc. In this modification, because the control device 24 has a configuration for acquiring the pressures of the pressure fluid in the pressure chambers 17 and 18 by performing the computation, the control device 24 corresponds to the operation state acquisition unit that acquires the operation state of the fluid pressure actuator 5. Although the modification of the fluid pressure driving device 100 is shown in FIG. 4 as this modification, this modification can also be applied to the fluid pressure driving devices 200 and 201.

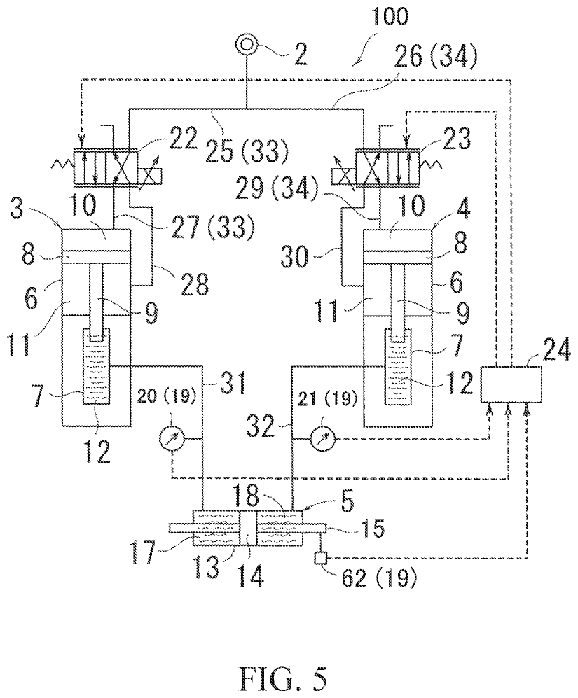

(5) For the fluid pressure driving devices 100, 200, and 201, the descriptions are given of the configurations in which the control device 24 controls the air pressure valves 22 and 23 on the basis of the pressures of the pressure fluid in the pressure chambers 17 and 18. Instead of this configuration, the control device 24 may control the air pressure valves 22 and 23 on the basis of the pressures of the pressure fluid in the pressure chambers 17 and 18 and the position of the rod 15. Specifically, the control device 24 sets the target values for the pressure of the pressure fluid in the first pressure chamber 17 and the pressure of the pressure fluid in the second pressure chamber 18 and performs the feedback control such that the piston 14 follows these target values, and the control device 24 sets a target value for the position of the rod 15 and performs the feedback control such that the piston 14 follows the target value. By doing so, an accuracy is improved for the control of the fluid pressure actuator 5. As shown in FIG. 5, the position of the rod 15 is acquired by a position acquisition unit 62 for detecting the position of the rod 15. For example, the position acquisition unit 62 is a stroke sensor that is provided on the fluid pressure actuator 5. The acquired results from the position acquisition unit 62 are output to the control device 24. In this modification, the pressure acquisition units 20 and 21 and the position acquisition unit 62 correspond to the operation state acquisition unit 19 for acquiring the operation states of the fluid pressure actuator 5.

(6) Instead of detecting the position of the rod 15 as the position acquisition unit as described in (5), it may be possible to acquire the position of the rod 15 by performing computation. For example, in the fluid pressure driving device 100 shown in FIG. 5, the position acquisition unit 62 provided on the fluid pressure actuator 5 is omitted, and a position sensor for detecting the position of the piston 8 is provided on each of the air-fluid converters 3 and 4. Detected values from the position sensors are then be output to the control device 24, and the position of the rod 15 is computed by the control device 24 on the basis of the detected values from the position sensors. Specifically, the control device 24 computes the position of the rod 15 by using a volume conservation formula determined from the positions of the pistons 8 detected by the position sensors and the pressure receiving areas of the pistons 8, the rods 9, and the piston 14 in consideration of flow rate losses at the fluid pressure paths 31 and 32, etc. As the position sensor for detecting the position of each of the pistons 8, a rod projecting outside from the cylinder 6 may be attached to each of the pistons 8, and thereafter, the stroke sensor for detecting the position of the rod may be provided on the cylinders 6. As the position sensor for detecting the position of each of the pistons 8, a magnet may be attached to each of the pistons 8, and a magnetic sensor for detecting the position of each of the pistons 8 in a non-contacting manner may be provided on each of the cylinders 6. In this modification, because the control device 24 has a configuration for acquiring the position of the rod 15 by performing the computation, the control device 24 corresponds to the operation state acquisition unit that acquires the operation state of the fluid pressure actuator 5. Although the modification of the fluid pressure driving device 100 shown in FIG. 5 is shown as this modification, this modification can also be applied to the fluid pressure driving devices 200 and 201. In a case of the fluid pressure driving device 200 shown in FIG. 2, the position sensor for detecting the position of the piston 36 may be provided on each of the air-fluid converters 3 and 4, and in a case of the fluid pressure driving device 201 shown in FIG. 3, the position sensor for detecting the position of the movable piston 49 may be provided on the fluid pressure cylinder 46.

(7) For the fluid pressure driving devices 100, 200, and 201, the descriptions are given of the configurations in which the control device 24 controls the air pressure valves 22 and 23 on the basis of the pressures of the pressure fluid in the pressure chambers 17 and 18. Instead of this configuration, the control device 24 may control the air pressure valves 22 and 23 on the basis of the pressures of the pressure fluid in the pressure chambers 17 and 18 and weight-load acting on the rod 15. Specifically, the control device 24 sets the target values for the pressure of the pressure fluid in the first pressure chamber 17 and the pressure of the pressure fluid in the second pressure chamber 18 and performs the feedback control such that the piston 14 follows these target values, and the control device 24 sets a target value for the weight-load on the rod 15 and performs the feedback control such that the piston 14 follows the target value. By doing so, an accuracy is improved for the control of the fluid pressure actuator 5. The control device 24 may also control the air pressure valves 22 and 23 on the basis of the pressures of the pressure fluid in the pressure chambers 17 and 18, the position of the rod 15, and the weight-load acting on the rod 15. The weight-load on the rod 15 is acquired by the weight-load acquisition unit for detecting the weight-load on the rod 15. For example, the weight-load acquisition unit is a weight-load sensor provided on the fluid pressure actuator 5. The acquired results from the weight-load acquisition unit are output to the control device 24. In this modification, the weight-load acquisition unit also corresponds to the operation state acquisition unit 19 for acquiring the operation state of the fluid pressure actuator 5. As the weight-load acquisition unit, it may be possible to acquire the weight-load on the rod 15 by performing computation. For example, the control device 24 computes the differential pressure acting on the piston 14 on the basis of the acquired results from the pressure acquisition units 20 and 21 and computes the weight-load on the rod 15 from the differential pressure and the pressure receiving area of the piston 14. In addition, as described above in (4), in a case in which the control device 24 computes the pressures of the pressure fluid in the pressure chambers 17 and 18 on the basis of the pressure of the air in the air pressure chambers 10, the control device 24 computes the differential pressure acting on the piston 14 from the pressure of the pressure fluid in the pressure chambers 17 and 18 acquired by the computation and computes the weight-load on the rod 15 from the differential pressure and the pressure receiving area of the piston 14. As described above, in a case in which the weight-load on the rod 15 is acquired by performing the computation, the control device 24 corresponds to the operation state acquisition unit for acquiring the operation state of the fluid pressure actuator 5.

The configurations, operations, and effects of the embodiments of the present invention will be collectively described below.

The fluid pressure driving device 100, 200, 201 has the configuration in which the pressure fluid is supplied from the first air-fluid converter 3 to the first pressure chamber 17 of the fluid pressure actuator 5, while the pressure fluid is supplied from the second air-fluid converter 4 to the second pressure chamber 18 of the fluid pressure actuator 5. Therefore, it is possible to realize the device capable of obtaining the practical fluid pressure with a low cost. In addition, it is possible to allow the fluid pressure actuator 5 to be reciprocated smoothly. In addition, the supply of the pressure fluid to the fluid pressure actuator 5 is controlled on the basis of the acquired results from the operation state acquisition unit 19 that acquires the operation state of the fluid pressure actuator 5. Thus, it is possible to achieve the reciprocating movement of the fluid pressure actuator 5 with a high accuracy by easily controlling the fluid pressure actuator 5 of the double rod type. In addition, the first air pressure valve 22 that is provided on the first air supply path 33 for supplying the air from the air pressure source 2 to the first air-fluid converter 3 and the second air pressure valve 23 that is provided on the second air supply path 34 for supplying the air from the air pressure source 2 to the second air-fluid converter 4 are controlled on the basis of the acquired results from the operation state acquisition unit 19. The air-fluid converters 3 and 4, to which the air is supplied via the air pressure valves 22 and 23 as described above, are each the air-hydro converter or the air-hydro booster. Thus, it is possible to control the supply of the air to the air-fluid converters 3 and 4, and in turn, it is possible to control the reciprocating movement of the fluid pressure actuator 5, by the configuration with a low cost.

In addition, in the fluid pressure driving device 200, the fluid pressure pump 41 capable of being rotated in both directions is connected to the first pressure chamber 17 via the first auxiliary path 44 and is connected to the second pressure chamber 18 via the second auxiliary path 45. Therefore, because the fluid pressure actuator 5 can be operated by driving the fluid pressure pump 41, it is possible to perform a more accurate control of the fluid pressure actuator 5.

In addition, the fluid pressure driving device 201 is provided with the fluid pressure cylinder 46 and the driving device 47 thereof. In the fluid pressure cylinder 46, the first liquid chamber 50 is connected to the first pressure chamber 17 via the first auxiliary path 44, and the second liquid chamber 51 is connected to the second pressure chamber 18 via the second auxiliary path 45. The driving device 47 is means that causes the movable piston 49 in the fluid pressure cylinder 46 to be reciprocated. Therefore, because the fluid pressure actuator 5 can be operated by causing the movable piston 49 of the fluid pressure cylinder 46 to be reciprocated by the driving device 47, it is possible to perform a more accurate control of the fluid pressure actuator 5.

Furthermore, in the fluid pressure driving devices 100, 200, and 201, because the first air pressure valve 22 and the second air pressure valve 23 are each the servovalve or the electro-pneumatic regulator, it is possible to adjust the flow rate or the pressure of the air to be supplied to the air-fluid converters 3 and 4.

Embodiments of this invention were described above, but the above embodiments are merely examples of applications of this invention, and the technical scope of this invention is not limited to the specific constitutions of the above embodiments.

This application claims priority based on Japanese Patent Application No. 2019-184405 filed with the Japan Patent Office on Oct. 7, 2019, the entire contents of which are incorporated into this specification.

1. A fluid pressure driving device comprising:
a first air-fluid converter and a second air-fluid converter that are each an air-hydro booster, the air-hydro booster being configured to convert air pressure supplied from an air pressure source to boosted fluid pressure;
a fluid pressure actuator having: a hollow cylinder chamber; a piston provided in the cylinder chamber so as so be reciprocatable; and a rod provided on the piston, an interior of the cylinder chamber being delimited into a first pressure chamber and a second pressure chamber by the piston, pressure fluid being supplied from the first air-fluid converter to the first pressure chamber, and the pressure fluid being supplied from the second air-fluid converter to the second pressure chamber;
an operation state acquisition unit configured to acquire an operation state of the fluid pressure actuator;
a first air pressure valve provided on a first air supply path, the first air supply path being configured to supply air from the air pressure source to the first air-fluid converter;
a second air pressure valve provided on a second air supply path, the second air supply path being configured to supply the air from the air pressure source to the second air-fluid converter; and
a control device configured to control the fluid pressure actuator, wherein
the first air-fluid converter and the second air-fluid converter each has:
a large-diameter cylinder and a small-diameter cylinder having different inner diameters;
a piston provided in the large-diameter cylinder so as to be reciprocatable;
a first air pressure chamber and a second air pressure chamber delimited in the large-diameter cylinder by the piston;
a rod provided on the piston; and
a fluid pressure chamber provided in the small-diameter cylinder, the fluid pressure chamber being configured such that the rod enters the fluid pressure chamber as the piston is moved,
the air is supplied to the first air pressure chamber or the second air pressure chamber of the first air-fluid converter through the first air pressure valve,
the air is supplied to the first air pressure chamber or the second air pressure chamber of the second air-fluid converter through the second air pressure valve,
the fluid pressure chamber of the first air-fluid converter is connected to the first pressure chamber of the fluid pressure actuator,
the fluid pressure chamber of the second air-fluid converter is connected to the second pressure chamber of the fluid pressure actuator, and
the control device is configured to reciprocate the rod of the fluid pressure actuator by controlling the first air pressure valve and second air pressure valve on the basis of an acquired result from the operation state acquisition unit.

2. The fluid pressure driving device according to claim 1, further comprising:
a first liquid supply valve provided on a first fluid pressure path, the first fluid pressure path being configured to supply the pressure fluid from the first air-fluid converter to the first pressure chamber;
a second liquid supply valve provided on a second fluid pressure path, the second fluid pressure path being configured to supply the pressure fluid from the second air-fluid converter to the second pressure chamber; and
a fluid pressure pump capable of being rotated in both directions, the fluid pressure pump being connected to the first pressure chamber via a first auxiliary path, and the fluid pressure pump being connected to the second pressure chamber via a second auxiliary path, wherein
the control device is further configured to control the fluid pressure actuator by controlling the fluid pressure pump on the basis of the acquired result from the operation state acquisition unit.

3. The fluid pressure driving device according to claim 1, further comprising:
a first liquid supply valve provided on a first fluid pressure path, the first fluid pressure path being configured to supply the pressure fluid from the first air-fluid converter to the first pressure chamber;
a second liquid supply valve provided on a second fluid pressure path, the second fluid pressure path being configured to supply the pressure fluid from the second air-fluid converter to the second pressure chamber; and
a fluid pressure cylinder having a hollow cylinder main body and a movable piston provided in the cylinder main body so as to be reciprocatable, an interior of the cylinder main body being delimited into a first liquid chamber and a second liquid chamber by the movable piston; and
a driving device configured to cause the fluid pressure cylinder to be reciprocated, wherein
the first liquid chamber is connected to the first pressure chamber via a first auxiliary path,
the second liquid chamber is connected to the second pressure chamber via a second auxiliary path, and
the control device is further configured to
control the fluid pressure actuator by controlling the fluid pressure cylinder on the basis of the acquired result from the operation state acquisition unit.

4. The fluid pressure driving device according to claim 1, wherein
the first air pressure valve and the second air pressure valve are each a servovalve or an electro-pneumatic regulator.

5. The fluid pressure driving device according to claim 1, wherein
the operation state acquisition unit acquires pressure of the pressure fluid in the first pressure chamber and pressure of the pressure fluid in the second pressure chamber.

6. The fluid pressure driving device according to claim 1, wherein
the operation state acquisition unit acquires a position of the rod of the fluid pressure actuator.

7. The fluid pressure driving device according to claim 1, further comprising:
a pressure sensor provided on the first air-fluid converter, the pressure sensor being configured to detect pressure of the air in the first air pressure chamber; and
a pressure sensor provided on the second air-fluid converter, the pressure sensor being configured to detect pressure of the air in the first air pressure chamber, wherein
the operation state acquisition unit is configured to acquire pressure of the first pressure chamber of the fluid pressure actuator by performing computation on the basis of a detected value from the pressure sensor provided on the first air-fluid converter, and acquire pressure of the second pressure chamber of the fluid pressure actuator by performing computation on the basis of a detected value of the pressure sensor provided on the second air-fluid converter.

8. The fluid pressure driving device according to claim 1, further comprising
a position sensor provided on each of the first air-fluid converter and the second air-fluid converter, the position sensor being configured to detect a position of the piston, wherein
the operation state acquisition unit is configured to acquire a position of the rod of the fluid pressure actuator by performing computation on the basis of a detected value from the position sensor.
